(19) United States
(12) Patent Application Publication
(10) Pub. No.: US 2003/0088420 A1
(43) Pub. Date: May 8, 2003

(54) Electronic program guide for processing content-related information configured using a reference information model

(75) Inventors: Yasser alSafadi, Yorktown Heights, NY (US); Amr F. Yassin, Ossining, NY (US); Alfredo Tirado-Ramos, Ossining, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/902,185

(22) Filed: Jul. 10, 2001

(51) Int. Cl. G10L 11/00

(52) U.S. Cl. 704/270.1

(57) ABSTRACT

Electronic program guide (EPG) processing techniques are disclosed which involve processing content-related information in the form of documents generated using a reference information model (RIM). The documents may be configured in an extensible mark-up language (XML) or other standard format. At least a portion of the content-related information is configured for consistency with corresponding portions of the RIM, the portion of the content-related information so configured thereby being suitable for processing by different EPG applications. The RIM preferably comprises multiple classes of information, and specifies properties of the classes utilizing attributes, relationships and states. For example, instances of the classes may be configured as objects in an object-oriented programming format, and one or more of the objects may contain structures represented as attributes. The RIM may be generated utilizing an iterative process in which progressively more inclusive versions are generated by modifying previous versions to support additional data specifications.

### FIELD OF THE INVENTION

The present invention relates generally to electronic program guides (EPGs) utilized to facilitate access to content, and more particularly to techniques for configuring EPGs to process content-related information in the form of extensible mark-up language (XML) documents.

### BACKGROUND OF THE INVENTION

EPGs are essential tools for management of the ever-increasing array of content available from information sources such as broadcast, satellite, cable and the Internet. As is well known, EPGs are generally associated with televisions, set-top boxes, personal video recorders (PVRs) or other similar devices, and can provide users of such devices with detailed information regarding available content, including titles, transmission times, actor lists, ratings, recommendations, etc.

A significant problem with existing EPGs is that there is no mechanism available to provide sufficient compatibility between the widely diverse applications that generate content. As a result, content generated by one application for a device having a particular type of EPG may not be configured in a manner suitable for processing by another device having a different type of EPG. Different devices are therefore generally required to have different EPGs, each specifically configured to operate with the particular content accessible via the corresponding device. This conventional approach requires excessive duplication of EPG resources, and unduly limits user accessibility to content-related information.

It is also well known to utilize standard formats for delivery of content over computer networks such as the Internet. An example of one such standard format is the extensible mark-up language (XML), described in XML 1.0 (Second Edition), World Wide Web Consortium (W3C) Recommendation, October 2000, www. w3.org/TR/REC-xml, which is incorporated by reference herein. However, XML and other similar standard formats often fail to capture adequately the semantics used in content generation for different applications. For example, there is considerable heterogeneity in the semantics of EPG field names, reflecting a lack of agreement among system developers in this area. Therefore, sets of XML documents from different sources and corresponding EPG-equipped devices will id generally not have the desired interoperability in the absence of a difficult-to-obtain specific prior agreement upon semantic definitions.

As is apparent from the foregoing, a need exists in the art for techniques that can allow different types of content from different sources to be configured in a standardized manner suitable for efficient processing by different EPGs, while avoiding the above-noted problems associated with the conventional approaches.

### SUMMARY OF THE INVENTION

The present invention meets the above-noted need by providing an electronic program guide (EPG) for processing of extensible mark-up language (XML) documents and other content-related information configured in accordance with a reference information model (RIM). The RIM is designed such that XML documents or other content-related information can be generated therefrom in a consistent manner so as to be suitable for processing by a wide variety of different EPG applications.

In accordance with one aspect of the invention, at least a portion of the content-related information is configured for consistency with corresponding portions of the RIM, the portion of the content-related information so configured thereby being suitable for processing by different EPG applications.

The RIM preferably comprises multiple classes of information, and specifies properties of the classes utilizing attributes, relationships and states. For example, instances of the classes may be configured as objects in an object-oriented programming format, and one or more of the objects may contain structures represented as attributes. In an illustrative embodiment, the RIM includes multiple enumeration elements and multiple class elements, with a given one of the class elements being associated with at least a subset of the enumeration elements and at least a subset of the remaining class elements. By way of example, the given class element for content may be a program class element, and the remaining class elements may include class elements for movie, episode, personnel, cast, credits, station and designated market area.

In accordance with another aspect of the invention, the RIM may be generated utilizing an iterative process in which progressively more inclusive versions are generated by modifying previous versions to support additional data specifications. For example, an initial version of the RIM may be generated using a first set of data specifications, and at least one subsequent version of the RIM may be generated from the initial version using at least a second set of data specifications. The subsequent version of the RIM may be periodically updated in accordance with one or more sets of updated data specifications, as such updated specifications become available.

In accordance with yet another aspect of the invention, the content-related information may be transformed from a first format not compliant with the RIM to a second format compliant with the RIM. The content-related information in the first format may comprise one or more documents for use with an EPG application of a type not based on the RIM, and may be subsequently converted into a desired RIM-compliant format. The transformation may utilize an XML style sheet generated at least in part utilizing the RIM and schema derived from the content-related information in the first format.

Advantageously, the present invention through use of the RIM ensures that content from diverse information sources can be processed in an efficient and effective manner by different EPGs, e.g., multiple EPGs associated with different processing devices of a residence, business or other user location. In addition, it allows XML documents developed for use with particular types of EPGs to be utilizable in an efficient manner on other EPGs. The invention also eases semantic verification of conformance claims between EPG applications from different developers, and can improve the marketability of a given EPG-based processing device. Moreover, the use of the RIM in the manner described can ensure internal consistency across the product lines of a given device manufacturer.

The invention thus facilitates the processing of EPG XML documents and other content-related information so as to deliver consistent results in an efficient manner.

These and other features and advantages of the present invention will become more apparent from the accompanying drawings and the following detailed description.

### BRIEF DESCRIPTION OF THE DRAWINGS

FIG. 1 is a block diagram of an example information processing system in which the present invention is implemented.

FIG. 2 shows a portion of an example reference information model (RIM) in accordance with an illustrative embodiment of the invention.

FIG. 3 illustrates the manner in which different types of documents may be generated utilizing a RIM such as that shown in FIG. 2.

FIG. 4 is a flow diagram of a process for generating, adjusting and updating a RIM such as that shown in FIG. 2.

FIG. 5 is a flow diagram of a process for transforming a set of documents, utilizing a RIM such as that shown in FIG. 2.

FIG. 6 shows one possible embodiment of a device in which an electronic program guide (EPG) in accordance the invention is implemented.

### DETAILED DESCRIPTION OF THE INVENTION

The present invention will be illustrated herein using an example information processing system and reference information model (RIM) for standardizing content-related information for processing by electronic program guides (EPGs). It should be understood, however, that the invention does not require the use of any particular system, RIM or EPG configuration, and is more generally suitable for use in any application involving an EPG in which it is desirable to provide improved processing of documents or other information in an extensible mark-up language (XML) format or other similar standardized format.

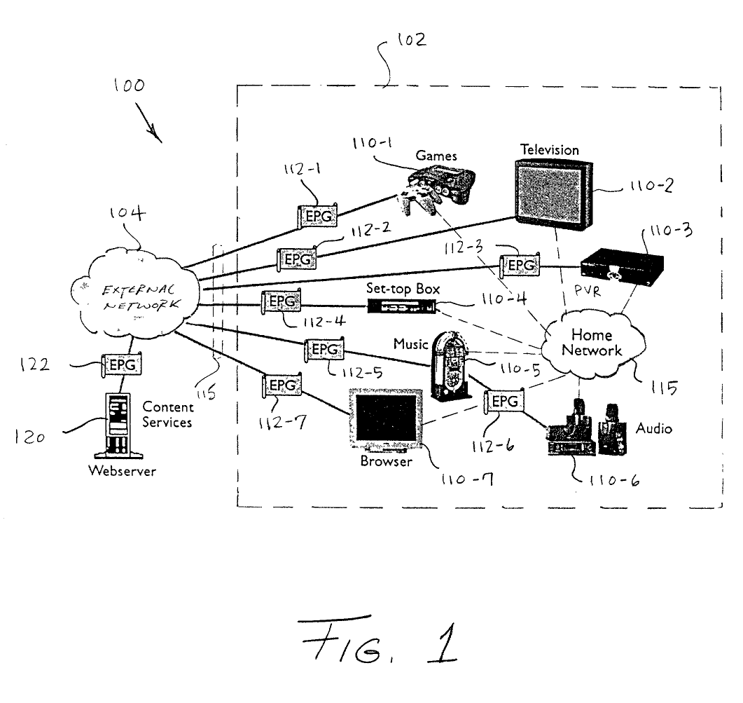

FIG. 1 shows an information processing system 100 that in this illustrative embodiment includes a residence 102 coupled to an external network 104. The residence 102 includes a number of processing devices 110 and corresponding EPGs 112. More particularly, the residence 102 includes a video game console 110-1, a television (TV) 110-2, a personal video recorder (PVR) 110-3, a set-top box 110-4, a music jukebox 110-5 and associated audio system 110-6, and a browser-equipped personal computer (PC) 110-7. Each of the processing devices 110-1, 110-2, . . . 110-7 has associated therewith a corresponding EPG 112-1, 112-2, . . . 112-7, respectively. The processing devices 110 are coupled to a home network 115 as shown.

Although described in conjunction with residence 102 in this embodiment, the invention can be implemented with any arrangement of one or more processing devices, e.g., mobile devices used away from a residence, or devices used within a business location or other enterprise. Moreover, although the EPGs 112 are shown in FIG. 1 as being separate from their corresponding processing devices 110, the EPGs 112 are typically implemented within their corresponding devices.

The external network 104 supplies content from one or more information sources to the processing devices 110 of the residence 102. The network 104 may represent a combination of multiple conventional networks, such as telephone, broadcast, satellite, cable, Internet and other networks, each being coupled to the residence 102 via a given channel in a set of communication channels 115.

By way of example, a single information source in the form of a web server 120 is shown in the figure, although numerous other information sources could be used in place of or in conjunction with the web server 120. The web server 120 provides content services to one or more of the processing devices 110 of the residence 102. Associated with the web server 120 is an EPG 122. The web server 120 and its associated EPG 122 may be configured to deliver content to the processing devices 110 in the form of XML documents transmitted over an Internet portion of the network 104, using well-known techniques such as Internet protocol (IP) and transmission control protocol (TCP).

The EPGs 112 in this illustrative embodiment preferably include conventional XML parsers that permit extraction of content-related information from documents supplied by the web server 120 or other information source.

An XML parser may be viewed as a software library used to facilitate XML document manipulations. Examples of conventional XML parsers include the Xerecs-J and Xerecs-C parsers, and the XP parser. Standard application programming interfaces (APIs) are used to provide predefined interfaces for one or more of these parsers. These APIs include DOM 1.0, described in Document Object Model (DOM) Level 1 Specification, Version 1.0, W3C Recommendation, October 1998, www.w3.org/TR/1998/REC-DOM-Level-1-19981001, which is incorporated by reference herein, and SAX, described in SAX 2.0, “The Simple API for XML,” www.megginson.com/SAX/sax.html, which is incorporated by reference herein. The above-noted Xerecs-J and Xerecs-C parsers implement both the DOM and SAX APIs, while the XP parser implements only the SAX API.

The term “document” as used in this context is intended to include not only XML documents, but any other file or arrangement of information that may be transmitted from an information source of the system 100 for utilization by one or more of the processing id devices 110 and/or an associated EPG 112.

The term “content-related information” as used herein is intended to be construed broadly so as to include content itself, as well as information characterizing content, and may be in the form of one or more documents.

It should be noted that the particular arrangement and configuration of elements shown in system 100 of FIG. 1 are by way of example only. In other embodiments, other types of servers, networks and processing devices may be used. Those skilled in the art will recognize that the EPG techniques of the present invention do not require any particular arrangement or configuration of such system elements.

In accordance with one aspect of the present invention, one or more of the EPGs 112 associated with residence 102 are configured to process XML documents generated using an EPG reference information model (RIM). Advantageously, the use of the RIM ensures that content from diverse information sources can be processed in an efficient and effective manner by different EPGs, e.g., the EPGs 112 of residence 102 in FIG. 1.

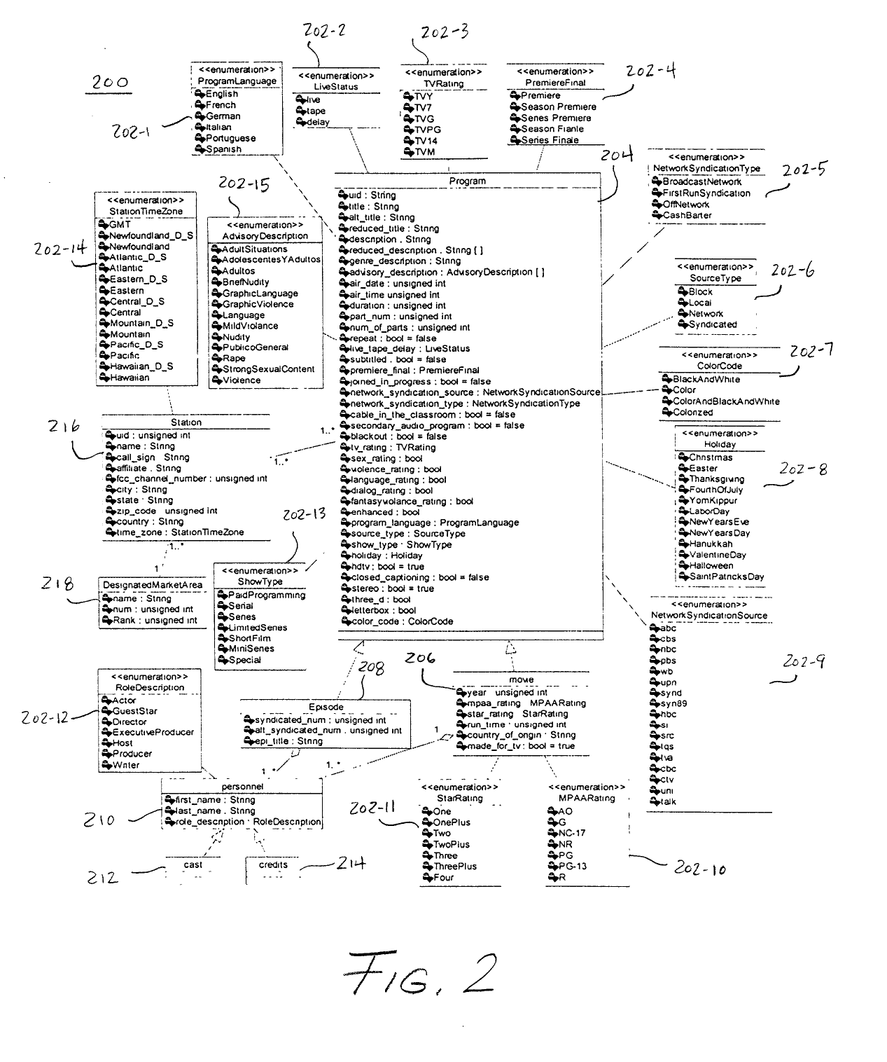

FIG. 2 shows an example of a RIM 200 in accordance with an illustrative embodiment of the invention. As will be described in detail below, the RIM 200 may be used to generate particular types of documents, e.g., XML documents, suitable for use with one or more of the processing devices 110 of the residence 102.

The RIM 200 includes interrelated elements arranged as shown, and is configured at least in part to model content-related information in a format similar to that described in Tribune Media Services, “Data specifications: TV schedules, U.S.” Version 2.0, Tribune Media Services, Jan. 29, 1999, and program listings from TV Data Technologies, www.tvdata.com, both of which are incorporated by reference herein.

Enumeration is used to describe constants within the modeled information. More particularly, the RIM 200 uses enumeration to describe constant elements 202-1, 202-2, . . . 202-15. The RIM 200 further includes class elements 204, 206, 208, 210, 212, 214, 216 and 218 for information classes denoted as program, movie, episode, personnel, cast, credits, station and designated market area, respectively. Additional details regarding each of the elements of the example RIM 200 can be found in the attached Appendix 1.

It can be seen from FIG. 2 that the program class 204 has directly or indirectly associated therewith the constant elements 202-1 through 202-15. Moreover, the program class 204 is directly or indirectly associated with each of the other classes 206, 208, 210, 212, 214, 216 and 218 as shown.

The RIM 200 in the illustrative embodiment of FIG. 2 is an object-oriented model implemented using the well-known Unified Modeling Language (UML). UML is a preferred modeling language in that it provides a modeling notation having well-defined semantics that can be interpreted unambiguously, but other types of modeling languages may be used to generate a RIM in accordance with the invention. It should also be noted that enhancements to the modeling approach of the illustrative embodiment can be enhanced by the use of Object Constraint Language (OCL)-compliant UML tools, as described at www.omg.org.

The RIM 200 may also make use of conventional information model techniques such as those described in “Message Development Framework,” HL7 Modeling and Methodology Committee, Version 3.2, April 1999.

The RIM 200 in the illustrative embodiment comprises a structured specification of the information requirements associated with one or more types of content. The RIM 200 expresses the classes of information required, and the properties of those classes including attributes, relationships, and states.

More particularly, the RIM 200 may be viewed as a structured specification of information requirements regarding exchange of content-related information. The RIM 200 provides a consistent view of the information being transmitted, as well as relationships to other information, in accordance with a specified semantic and syntactic consensus. This ensures that the content-related information exchanged is consistent and can be used by different EPG applications. The term “EPG application” as used herein is intended to include any particular instance of an EPG as implemented in conjunction with a given processing device, e.g., a given one of the EPGs 112 or 122 as illustrated in FIG. 1, as well as portions or combinations of these and other EPGS.

Advantageously, the RIM 200 includes well-defined classes, which represent content-related information suitable for processing by an EPG, and specifies relationships among such classes. In a typical implementation, as is apparent from the foregoing example of FIG. 2, individual instances of these classes exist as objects, and contain structures represented as attributes.

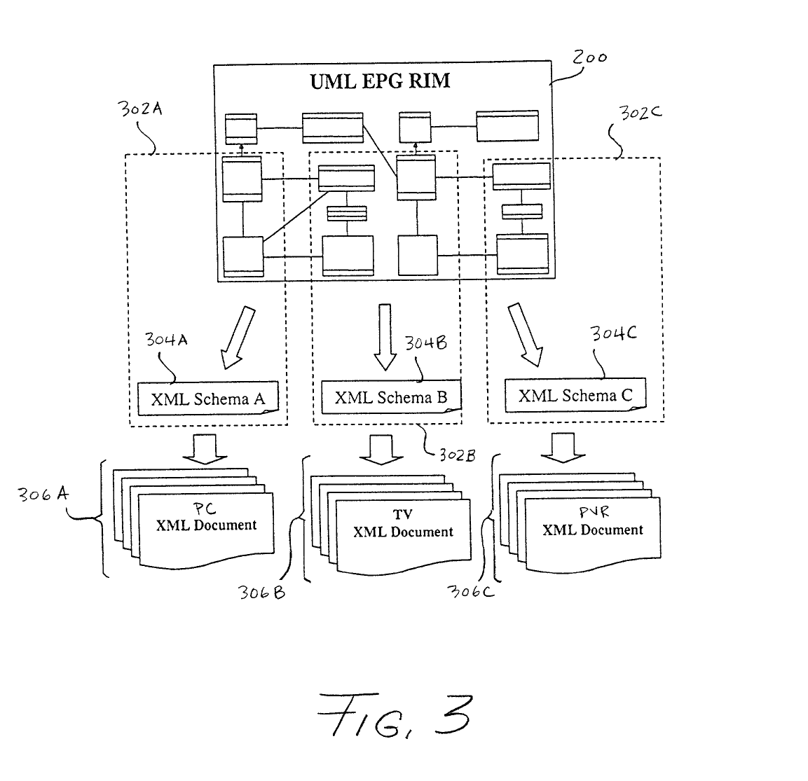

FIG. 3 illustrates the manner in which different types of XML documents may be generated utilizing the RIM 200 of FIG. 2. In the illustrated process, the RIM 200 is utilized to generate XML documents for three different processing devices of the FIG. 1 system, namely, a PC, TV and PVR, shown as respective elements 110-7, 110-2 and 110-3 in FIG. 1. More particularly, operations 302A, 302B, and 302C utilize respective first, second and third portions of the RIM 200 shown as falling within corresponding dashed boxes. The operations 302A, 302B and 302C generate different XML schema 304A, 304B and 304C, respectively. The XML schema 304A, 304B and 304C, also denoted as XML Schema A, XML Schema B and XML Schema C in the figure, are then used to generate sets of XML documents 306A, 306B and 306C for the PC, TV and PVR, respectively. The schema 304A, 304B and 304C may represent, e.g., normative portions of EPG configurations for particular processing devices as determined by standards bodies for presentation of content on those devices.

Advantageously, this process provides the desired consistency between XML documents or other content-related information generated for different EPG applications associated with different processing devices. The invention in other embodiments can provide similar advantages for different EPG applications running on a single processing device.

The FIG. 3 process can be implemented at least in part using otherwise conventional XML document generation tools such as those commercially available from Rational, www.rational.com, XML Authority, www.extensibility.com, and others.

An example XML schema generated from a portion of the RIM 200 using the XML Authority 1.2 toolkit is as follows:

<?xml version =“1.0”?>
<!−−Conforms to w3c http://www.w3.org/1999/XMLSchema−−>
<schema xmlns = “http://www.w3.org/1999/XMLSchema”>

<element name = “EPG”>

<complexType content = “elementOnly”>

<sequence>

<element ref = “Program”/>

</sequence>

</complexType>

</element>
<element name = “Program”>

<complexType content = “elementOnly”>

<sequence>

<element ref = “AdvisoryDescription”/>
</sequence>
<attribute name = “uid” type = “string”/>
<attribute name = “title” type = “string”/>
<attribute name = “advisory_description” type =

“string”/>

<attribute name = “air_date” type = “string”/>
<attribute name = “air_time” type = “string”/>
<attribute name = “duration” type = “string”/>

</complexType>

</element>
<element name = “AdvisoryDescription”>

<complexType base = “NMTOKEN” content = “textOnly”>

<attribute name = “AdultSituations” type =

“string”/>

<attribute name = “AdolescentesYAdultos” type =

“string”/>

<attribute name = “Adultos” type = “string”/>
<attribute name = “BriefNudity” type = “string”/>
<attribute name = “GraphicLanguage” type =

“string”/>

<attribute name = “GraphicViolence” type =

“string”/>

<attribute name = “Language” type = “string”/>
<attribute name = “MildViolence” type = “string”/>
<attribute name = “Nudity” type = “string”/>
<attribute name = “PublicoGeneral” type = “string”/>
<attribute name = “Rape” type = “string”/>
<attribute name = “StrongSexualContent” type =

“string”/>

<attribute name = “Violence” type = “string”/>

</complexType>

</element>

</schema>

As is apparent from this example, complete XML schema can be generated from the RIM 200 or from one or more suitable subsets thereof.

In accordance with another aspect of the invention, an iterative process for generating, adjusting and updating a RIM is provided.

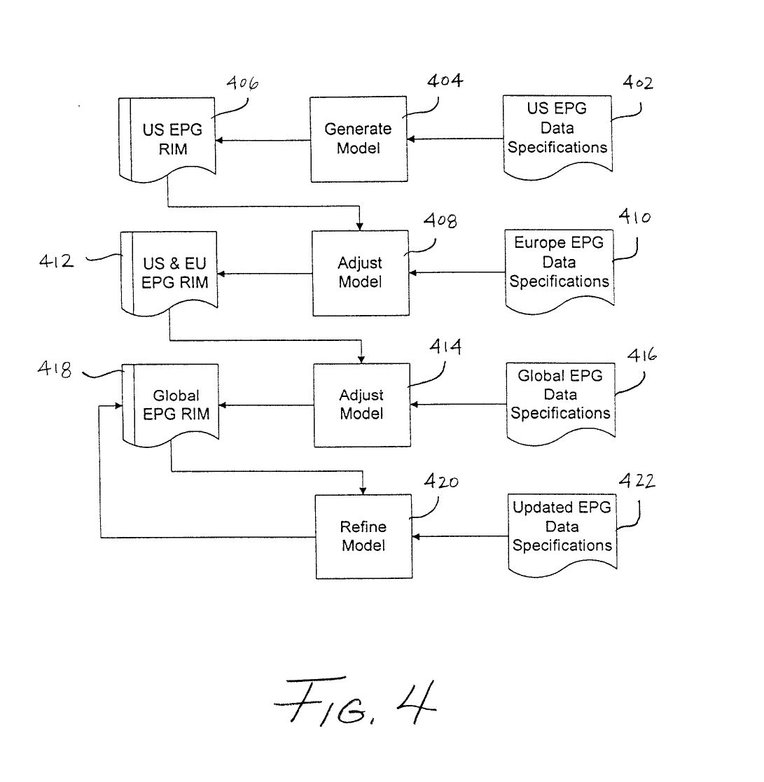

FIG. 4 is a flow diagram of the iterative process. In this process a set of U.S. EPG data specifications 402 is utilized in generation step 404 to generate a U.S. EPG RIM 406. An example of such a U.S. EPG RIM is the RIM 200 previously described in conjunction with FIGS. 2 and 3. The U.S. EPG RIM 406 is then adjusted in an adjustment step 408 utilizing Europe EPG data specifications 410. The result of the adjustment step 408 is a U.S. and European EPG RIM 412. The U.S. and European EPG RIM 412 is then itself adjusted in an adjustment step 414 utilizing global EPG data specifications 416. The result of the adjustment step 414 is global EPG RIM 418. This global EPG RIM 418 is subsequently updated in a refinement step 420 based on updated EPG data specifications 422.

In accordance with yet another aspect of the invention, a process is provided for transforming existing content-related information for use with other EPGs.

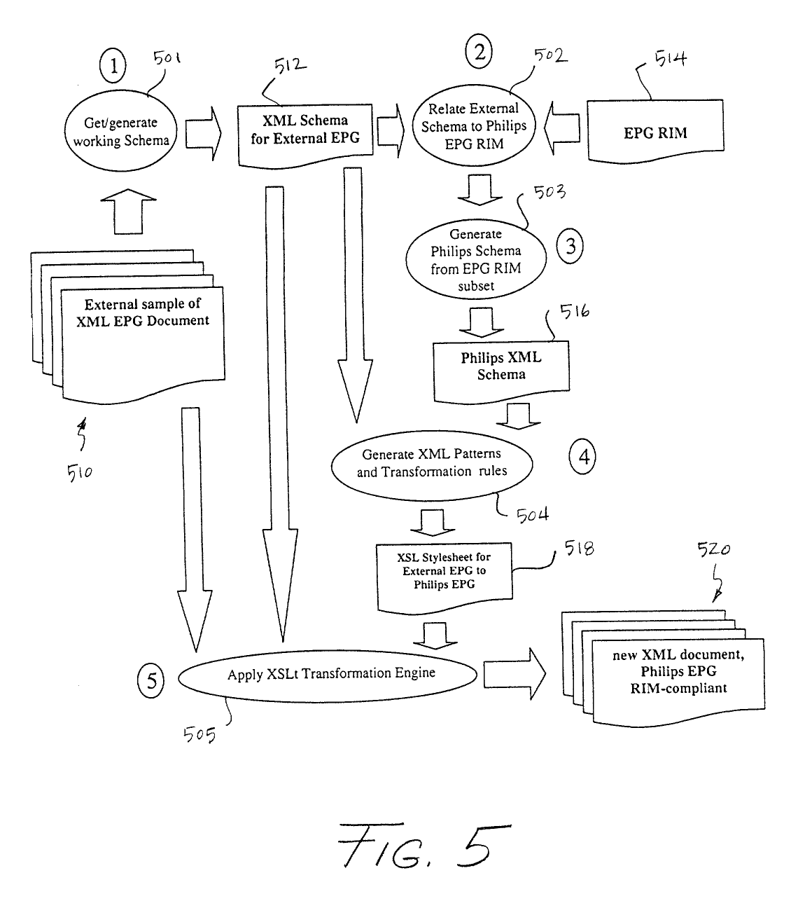

FIG. 5 is a flow diagram of an illustrative embodiment of the above-noted process. This embodiment of the process utilizes the RIM 200 to transform a set of XML documents generated for use with an “external” EPG so as to be suitable for processing on another, different type of EPG. The FIG. 5 process includes steps 501, 502, 503, 504 and 505, also denoted generally as steps 1 through 5, respectively.

In step 501, working XML schema are generated or otherwise obtained from a set of external XML EPG documents 510. The result of step 501 is one or more XML schema 512 for the external EPG.

An EPG RIM 514 is used in the FIG. 5 process. It is assumed without limitation that the EPG RIM 514 is associated with one or more particular EPG developers, e.g., Philips Electronics (hereinafter “Philips”). The documents 510 are referred to as “external” in this embodiment in that they are assumed to be associated with another EPG developer external to the particular EPG developer(s).

In step 502, the XML schema 512 for the external EPG are related to the EPG RIM 514, e.g., by checking for syntax and semantics consistency. Then, in step 503, one or more Philips XML schema 516 are generated from an appropriate subset of the EPG RIM 514 as identified in step 502.

Step 504 utilizes the external XML schema 512 and the Philips XML schema 516 to generate XML patterns and XSLt transformation rules. The result of this step is an XML stylesheet 518 for transforming the external XML EPG documents 510 to new XML documents 520 that are compliant with the Philips EPG RIM 514. The XML stylesheet 518 may be applied to a conventional XSLt transformation engine as indicated in step 505, so as to transform the external XML EPG documents to the new Philips RIM-compliant XML EPG documents 520.

The FIG. 5 process thus maps the external EPG XML schema 512 to an appropriate subset of the EPG RIM 514 so as to create new, RIM compliant schema 516. The RIM-compliant schema 516 are further processed to generate the XSL stylesheet 518 that is utilized to convert the external EPG XML documents 510 to the RIM-compliant documents 520.

The use of a RIM such as that described above for generation of EPG XML documents provides a number of significant advantages relative to conventional techniques. For example, it allows XML documents developed for use with particular types of EPGs to be utilizable in an efficient manner on other EPGs. In addition, this approach eases semantic verification of EPG XML conformance claims between applications from different sources. An appropriate level of conformance can also improve the marketability of a given EPG-based processing device. Moreover, the use of the RIM in the manner described can ensure internal consistency across the product lines of a given device manufacturer.

The invention thus facilitates the processing of EPG XML documents and other content-related information so as to deliver consistent results in an efficient manner.

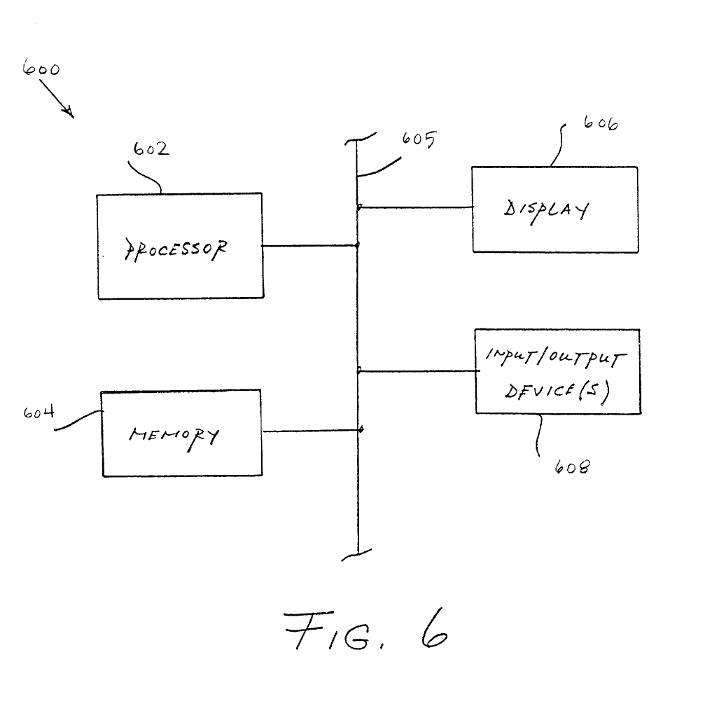

FIG. 6 shows an example of a processing device 600 in which an EPG configured using the techniques of the invention may be implemented.

The device 600 includes a processor 602 and a memory 604 which communicate over at least a portion of a set 605 of one or more system buses. Also utilizing at least a portion of the set 605 of system buses are a display 606 and one or more input/output (I/O) devices 608.

The device 600 may represent one or more of the devices 110 of the FIG. 1 processing system, or any other type of processing device that incorporates an EPG, and the elements of the device 600 may be conventional elements of such devices.

For example, the processor 602 may represent a microprocessor, central processing unit (CPU), digital signal processor (DSP), or application-specific integrated circuit (ASIC), as well as portions or combinations of these and other processing devices. The memory 604 is typically an electronic memory, but may comprise other types of storage devices, such as disk-based optical or magnetic memory.

The EPG techniques described herein may be implemented in whole or in part using software stored and executed using the respective memory and processor elements of the device 600. For example, one or more of the EPGs 112 of the FIG. 1 system may be implemented at least in part using one or more software programs stored in memory 604 and executed by processor 602. The particular manner in which such software programs may be stored and executed in device elements such as memory 604 and processor 602 is well understood in the art and therefore not described in further detail herein.

It should be noted that the device 600 may include other elements not shown, or other types and arrangements of elements capable of providing the EPG processing functions described herein.

The FIG. 6 processing device may also be used to process content-related information for delivery to another processing device equipped with an EPG, e.g., using the techniques described in conjunction with FIGS. 3, 4 and 5.

The above-described embodiments of the invention are intended to be illustrative only. For example, the invention can be used in other types of information processing systems and devices using other arrangements of processing elements. In addition, as indicated above, the particular details of the RIM used in a given embodiment of the invention will vary depending upon the type of content to be delivered. These and numerous other alternative embodiments within the scope of the following claims will be apparent to those skilled in the art.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for processing content-related information for delivery to a processing device configured to support an electronic program guide of a first type, the method comprising the steps of:
determining a reference information model for use with the content-related information; and
configuring at least a portion of the content-related information for consistency with corresponding portions of the reference information model, the portion of the content-related information so configured thereby being suitable for processing by at least the electronic program guide of the first type.

2. The method of claim 1 wherein the configured portion of the content-related information is suitable for processing by the electronic program guide of the first type and at least a second electronic program guide of a second type different than the first type.

3. The method of claim 1 wherein the content-related information comprises one or more documents in an extensible mark-up language.

4. The method of claim 1 wherein the reference information model comprises a plurality of classes of information, and specifies properties of the classes utilizing one or more attributes, relationships and states.

5. The method of claim 1 wherein the reference information model comprises a plurality of elements including one or more enumeration elements and one or more class elements, a given one of the class elements being associated with at least a subset of the enumeration elements and at least a subset of the remaining class elements.

6. The method of claim 5 wherein the given one of the class elements comprises a program class element, and the remaining class elements comprise one or more of movie, episode, personnel, cast, credits, station and designated market area class elements.

7. The method of claim 5 wherein instances of the classes are configured as objects in an object-oriented programming format, and one or more of the objects contain structures represented as attributes.

8. The method of claim 1 wherein the reference information model is configured in accordance with a unified modeling language format.

9. The method of claim 1 wherein the configuring step further comprises generating one or more schema associated with the electronic program guide of the first type, the schema being generated based at least in part on an associated portion of the reference information model, and utilizing the schema to generate one or more documents comprising the content-related information.

10. The method of claim 9 wherein the configuring step further comprises generating a plurality of different schema, each of the schema being associated with one or more of the electronic program guide of the first type and an electronic program guide of a second type different than the first type, each of the schema being utilized to generate one or more documents comprising the content-related information.

11. The method of claim 1 wherein the reference information model is generated utilizing an iterative process in which an initial version of the model is generated using a first set of data specifications, and at least one subsequent version of the model is generated from the initial version using at least a second set of data specifications.

12. The method of claim 11 wherein the at least one subsequent version of the model is periodically updated in accordance with one or more sets of updated data specifications.

13. The method of claim 1 wherein the configuring step comprises transforming the content-related information from a first format not compliant with the reference information model to a second format compliant with the reference information model.

14. The method of claim 13 wherein the content-related information in the first format comprises one or more documents for use with an electronic program guide of a type not based on the reference information model, and further wherein the documents are converted to the second format so as to be utilizable at least by the electronic program guide of the first type.

15. The method of claim 13 wherein the transforming step utilizes an extensible mark-up language style sheet generated at least in part utilizing the content-related information in the first format and the reference information model.

16. A method for use in a processing device configured to support an electronic program guide of a first type for processing content-related information, the method comprising the steps of:
receiving the content-related information, at least a portion of the content-related information being configured for consistency with corresponding portions of a reference information model, the portion of the content-related information so configured thereby being suitable for processing by at least the electronic program guide of the first type; and
processing the content-related information to generate a corresponding output at the processing device.

17. An apparatus for processing content-related information for delivery to a processing device configured to support an electronic program guide of a first type, the apparatus comprising:
a processor operative to configure at least a portion of the content-related information for consistency with corresponding portions of a reference information model, the portion of the content-related information so configured thereby being suitable for processing by at least the electronic program guide of the first type; and
a memory coupled to the processor, for at least temporarily storing at least a portion of the content-related information.

18. An apparatus associated with a processing device configured to support an electronic program guide of a first type for processing content-related information, the apparatus comprising:
a processor operative to implement at least a portion of the electronic program guide of the first type for processing the content-related information, at least a portion of the content-related information being configured for consistency with corresponding portions of a reference information model, the portion of the content-related information so configured thereby being suitable for processing by at least the electronic program guide of the first type; and
a memory coupled to the processor, for at least temporarily storing at least a portion of the content-related information.

19. An article of manufacture comprising a machine-readable storage medium containing one or more software programs for processing content-related information for delivery to a processing device configured to support an electronic program guide of a first type, wherein the one or more software programs when executed implement the steps of:
determining a reference information model for use with the content-related information; and
configuring at least a portion of the content-related information for consistency with corresponding portions of the reference information model, the portion of the content-related information so configured thereby being suitable for processing by at least the electronic program guide of the first type.
